(19) United States
(12) Patent Application Publication
(10) Pub. No.: US 2008/0158476 A1
(43) Pub. Date: Jul. 3, 2008

(54) Optical member, backlight unit and display apparatus having the same

(75) Inventor: Junji Miyashita, Fujiyoshida-city (JP)

Correspondence Address: BRINKS HOFER GILSON & LIONE, P.O. BOX 10395, CHICAGO, IL, 60610, US

(73) Assignee: Citizen Electronics Co., Ltd., Fujiyoshida-shi (JP)

(21) Appl. No.: 11/950,779

(22) Filed: Dec. 5, 2007

(30) Foreign Application Priority Data
Dec. 6, 2006 (JP) JP2006-330032
Apr. 12, 2007 (JP) JP2007-104414

(51) Int. Cl. G02F 1/1335

(52) U.S. Cl. 349/65

(57) ABSTRACT

An optical member having high directivity in a direction perpendicular to an exit surface thereof includes a transparent lens layer (3) having a front surface (exit surface) and a back surface and having a plurality of convex lenses on the front surface. A light-absorbing layer (4) and a light-reflecting layer (5) are successively stacked on the back surface of the transparent lens layer. A plurality of optical windows (6) extend through the light-absorbing and light-reflecting layers in the direction of stacking of the light-reflecting layer, the light-absorbing layer and the transparent lens layer so as to align with the convex lenses, respectively. The convex lenses have one common focal plane located outside the optical member. The focal plane is adjacent and parallel to the light-reflecting layer.

### RELATED APPLICATIONS

This application claims priority under 35 U.S.C. § 119 to Japanese Patent Application No. JP2006-330032 filed Dec. 6, 2006 and Japanese Patent Application No. JP2007-104414 filed Apr. 12, 2007, the entire contents of which are hereby incorporated by reference.

### TECHNICAL FIELD

The present invention relates to display apparatus such as liquid crystal display apparatus. More particularly, the present invention relates to a technique of suppressing emission of light in oblique directions relative to the display surface of a display apparatus to make it difficult to peep at the display surface from the oblique directions, and also to increase the luminance of the display surface as viewed from directly in front of it.

### RELATED CONVENTIONAL ART

Liquid crystal display apparatus for image display have been widely used in mobile phones, personal digital assistants (PDAs), automatic teller machines (ATMs), displays of personal computers, etc. These liquid crystal display apparatus employ a backlight unit that applies illuminating light to a liquid crystal display panel from the back thereof to enhance the luminance of the display screen.

Recently, there has been a demand that liquid crystal display apparatus should be improved in visibility of the display screen as viewed from directly in front of it and that the visibility thereof as viewed obliquely sideways should be limited according to the use environment of the apparatus. For example, an individual may want to see the liquid crystal display of a mobile phone or to operate on the operating screen of an ATM at a bank or the like privately without another person peeping sideways at an image or information displayed on the display screen during use.

As an example of peep preventing sheets or films usable for the above-described purpose, Japanese Patent Application Publication No. Hei 5-94731 proposes an antiglare sheet for an illuminated display that comprises a repeated stack of a white layer, a black layer, a transparent layer and a black layer. The antiglare sheet suppresses diffusion of light by the light-blocking effect of the black layers. Japanese Patent Application Publication No. 2003-131202 proposes a peep preventing member for an information display that has an antiglare layer formed by alternately arranging a plurality of transparent silicone rubber sheets and colored silicone rubber sheets into an integrated layer. The peep preventing member prevents a third person from peeping sideways at the display by the antiglare effect of the antiglare layer.

Meanwhile, Japanese Patent Application Publication No. 2006-145653 proposes an optical member sheet that is usable in place of a prism sheet of a backlight unit. The optical member sheet comprises a light-transmitting resin substrate having a multiplicity of convex lens-shaped elements formed on one surface thereof and further comprises a reflecting layer provided on the other surface of the light-transmitting resin substrate so as to correspond to the boundary between each pair of adjacent convex lens-shaped elements. In this optical member sheet, rays of emitted light are collected in a direction perpendicular to the surface of the optical member sheet (i.e. in the directly forward direction relative to the surface of the optical member sheet) by the plurality of convex lens-shaped elements, thereby improving the forward luminance of the display surface (i.e. the luminance of the display surface as viewed from directly in front of it).

The above-described conventional techniques, however, still have the following problems to be solved. With the techniques disclosed in Japanese Patent Application Publication Nos. Hei 5-94731 and 2003-131202, the desired sheet is made by stacking a multiplicity of colored sheets and transparent sheets and slicing the resulting stack of sheets. Therefore, the production cost is high. In addition, because light is blocked only by the colored layers arranged in series with a predetermined gap therebetween, light traveling obliquely between mutually adjacent colored layers undesirably leaks in an oblique direction other than the directly forward direction relative to the surface of the sheet. With the technique disclosed in Japanese Patent Application Publication No. 2006-145653, light rays are concentrated in the directly forward direction by a plurality of convex lens-shaped elements. However, the optical member sheet merely changes the travel direction of light obliquely incident on the sheet to the directly forward direction as in the case of an ordinary prism sheet. Therefore, it is impossible to expect a substantial increase in the forward luminance of the display surface. In addition, there occurs a leakage of light in oblique directions.

### SUMMARY OF THE INVENTION

The present invention has been made in view of the above-described circumstances. Accordingly, an object of the present invention is to provide a sheet-shaped optical member capable of being produced at a reduced cost and also capable of suppressing emission of light in oblique directions from an exit surface thereof. Another object of the present invention is to provide a backlight unit using the optical member of the present invention. Still another object of the present invention is to provide a display apparatus using the backlight unit of the present invention.

The present invention provides an optical member including a transparent lens layer having a front surface and a back surface. The transparent lens layer has a plurality of convex lenses on the front surface. The optical member further includes a light-absorbing layer and a light-reflecting layer successively stacked on the back surface of the transparent lens layer. Further, the optical member includes a plurality of optical windows extending through the light-absorbing layer and the light-reflecting layer in the direction in which the light-reflecting layer, the light-absorbing layer and the transparent lens layer are successively stacked. The optical windows are aligned with the convex lenses, respectively. The convex lenses have one common focal plane located outside the optical member. The focal plane is adjacent and parallel to the light-reflecting layer.

In the optical member, a planar light source is provided at the back side of the optical member, and the exit surface of the planar light source is set so as to be coincident with the above-described focal plane. With this arrangement, light emitted from the exit surface is narrowed down through each optical window before entering the optical member. Obliquely incident light that impinges on the light-absorbing layer is blocked from scattering by the light-absorbing layer. Light entering a convex lens corresponding to the optical window exits from the convex lens as parallel rays.

One specific example of the optical member may be as follows. The convex lenses are arranged in a matrix on the front surface of the transparent lens layer. The convex lenses each have a spherical convex surface. The optical windows are circular windows aligned with the convex lenses, respectively, in the stacking direction.

Another specific example of the optical member may be as follows. The convex lenses respectively have elongated convex surfaces of arcuate cross-section that extend parallel to each other on the front surface of the transparent lens layer. The optical windows are elongated slits aligned with the elongated convex surfaces, respectively, in the stacking direction.

In a case where the convex lenses have elongated convex surfaces, directivity of light is high in a direction perpendicular to the front surface of the transparent lens layer in a plane perpendicular to the length direction of the convex lenses. In a case where the convex lenses each have a spherical convex surface, directivity of light is high in any plane perpendicular to the transparent lens layer.

In addition, the present invention provides a backlight unit including the above-described optical member and a backlight part serving as a planar light source that applies light to the optical member from a side thereof closer to the light-reflecting layer. The focal plane of the convex lenses of the optical member is substantially coincident with a light exit surface of the backlight part that faces the optical member.

In this backlight unit, light emitted from the exit surface and reaching the convex lenses through the optical windows is allowed to exit as substantially parallel rays.

Specifically, the backlight part of the backlight unit may have a lightguide plate, a light source, and a prism sheet. The lightguide plate is disposed parallel to the optical member. The light source is disposed along a side edge surface of the lightguide plate to emit light into the lightguide plate. The prism sheet is provided between the lightguide plate and the optical member to direct light from the lightguide plate to the optical member.

In addition, the present invention provides a display apparatus including a light-transmissive image display panel and the above-described backlight unit that is disposed at the back side of the image display panel.

The backlight unit emits parallel rays of light as stated above, and the image display panel is illuminated with the parallel rays. Therefore, a minimum amount of light exits in obliquely sideward directions from the surface of the image display panel. Accordingly, the image display panel has a high forward luminance and can be made difficult to peep sideways.

The image display panel may be a liquid crystal display panel.

### BRIEF DESCRIPTION OF THE DRAWINGS

FIG. 1 is a sectional view of an optical member according to a first embodiment of the present invention.

FIG. 2 is a plan view of the optical member.

FIG. 3 is a schematic sectional view of a display apparatus having the optical member.

FIG. 4 is an enlarged sectional view of an essential part of the display apparatus.

FIG. 5 is a graph showing the results of simulation of directivity characteristics of a backlight unit of the display apparatus.

FIG. 6 is a graph showing the results of simulation of directivity characteristics of a conventional backlight unit.

FIG. 7 is a sectional view of an optical member according to a second embodiment of the present invention.

FIG. 8 is a plan view of the optical member shown in FIG. 7.

FIG. 9 is a schematic sectional view of a display apparatus having the optical member shown in FIG. 7.

FIG. 10 is an enlarged sectional view of an essential part of the display apparatus shown in FIG. 9.

FIG. 11 is a graph showing the results of simulation of directivity characteristics of a backlight unit of the display apparatus shown in FIG. 9.

FIG. 12 is a graph showing the results of simulation of directivity characteristics of a conventional backlight unit.

### DESCRIPTION OF THE PREFERRED EMBODIMENTS

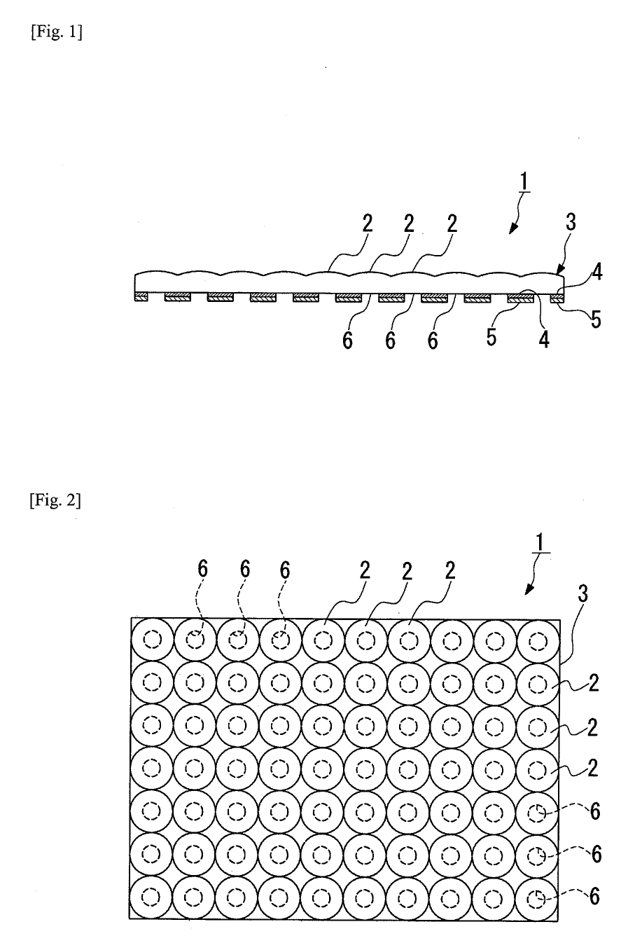

Embodiments of an optical member, a backlight unit and a display apparatus according to the present invention will be explained below with reference to accompanying FIGS. 1 to 12.

FIGS. 1 and 2 show an optical member 1 according to an embodiment of the present invention. The optical member 1 is in the shape of a sheet, a film or a plate and has a transparent lens layer 3 having a plurality of spherical convex lenses 2 arranged in a matrix on the front surface thereof. The optical member 1 further has a light-absorbing layer 4 superimposed on the back surface of the transparent lens layer 3 and a light-reflecting layer 5 superimposed on the back surface of the light-absorbing layer 4. The light-absorbing layer 4 and the light-reflecting layer 5 each have optical windows 6 directly below the apexes of the convex lenses 2.

The transparent lens layer 3 is formed from a light-transmitting resin, e.g. an epoxy resin, polyester, polycarbonate, or polyvinyl chloride. The constituent material and thickness of the transparent lens layer 3 should be properly selected in consideration of the specifications of the convex lenses 2 and so forth.

The light-absorbing layer 4 is a black layer of carbon or the like.

The light-reflecting layer 5 is a silver or white metal plate, film, foil or the like having a light-reflecting function. In this embodiment, the light-reflecting layer 5 is a film provided with an evaporated silver layer. It should be noted that an evaporated aluminum layer or the like may be used in place of the evaporated silver layer.

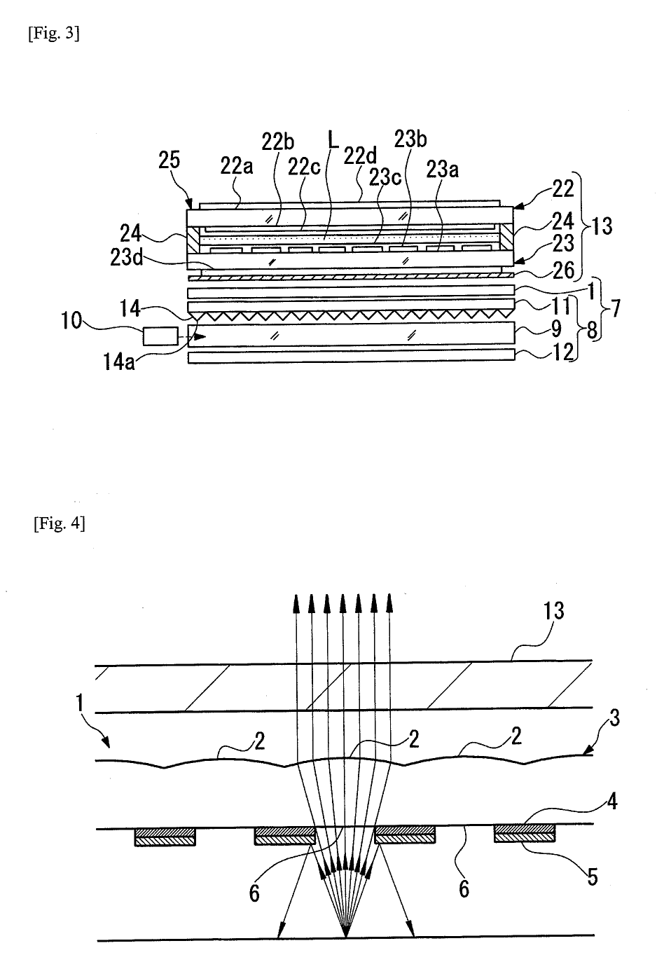

As shown in FIG. 3, a backlight unit 7 according to this embodiment has the above-described optical member 1 and a backlight part 8 as a planar light source that emits illuminating light toward the optical member 1.

The backlight part 8 has a lightguide plate 9, a light source 10, a prism sheet 11, and a reflecting sheet 12. The lightguide plate 9 is provided parallel to the optical member 1. The light source 10 is disposed along a side edge surface of the lightguide plate 9 to emit light into the lightguide plate 9. The prism sheet 11 is provided between the lightguide plate 9 and the optical member 1 to direct light from the lightguide plate 9 upward toward the optical member 1 as illuminating light. The reflecting sheet 12 is provided underneath the lightguide plate 9.

The optical member 1 and the backlight part 8 of the backlight unit 7 are related to each other so as to constitute an optical system in which light emitted from the exit surface of the backlight part 8 passes through the optical windows 6 and exits from the surfaces of the convex lenses 2 as parallel rays of light. That is, the convex lenses 2 of the optical member 1 are arranged to have one common focal plane that is substantially coincident with the exit surface of the backlight part 8. The inner diameter of the optical windows 6 should be properly determined by an image-forming optical system to be formed according to the distance between the optical member 1 and the backlight part 8 and the size and configuration of the convex lenses 2.

The prism sheet 11 is a transparent sheet-shaped member for collecting light from the lightguide plate 9 upwardly and has on its back side a plurality of elongated prisms 14 with ridges 14a parallel to each other. The optical axis of the light source 10 is set at a predetermined angle to the ridges 14a of the prisms 14 of the prism sheet 11 in plan view. To obtain high directivity in an upward direction, in particular, the optical axis of the light source 10 is set to perpendicularly intersect the ridges 14a of the prisms 14.

The lightguide plate 9 is formed from a transparent polycarbonate or acrylic resin, for example. The reflecting sheet 12 is formed from a metal plate, film or foil having a light-reflecting function. In this embodiment, a film provided with an evaporated aluminum layer is used as the reflecting sheet 12.

The light source 10 comprises a plurality of spaced white light-emitting diodes (LEDs) disposed along a side edge surface of the lightguide plate 9. The white LEDs are each formed by sealing a semiconductor light-emitting device on a substrate with a resin material. The LED element is, for example, a blue (wavelength λ: 470 to 490 nm) LED element or an ultraviolet (wavelength λ: less than 470 nm) LED element, which is formed, for example, by stacking a plurality of semiconductor layers of a gallium nitride compound semiconductor (e.g. InGaN compound semiconductor) on an insulating substrate, e.g. a sapphire substrate.

The resin material used to seal the semiconductor light-emitting device is formed by adding, for example, YAG fluorescent substance into a silicone resin as a main component. The YAG fluorescent substance converts blue or ultraviolet light from the semiconductor light-emitting device into yellow light, and white light is produced by color mixing effect. It should be noted that various LEDs in addition to those described above can be used as the white LEDs.

A display apparatus according to this embodiment is a liquid crystal display apparatus applicable, for example, to a liquid crystal display for use in a mobile phone, a personal digital assistant (PDA) or an automatic teller machine (ATM). The display apparatus has a liquid crystal display panel 13 and the above-described backlight unit 7 provided at the back of the liquid crystal display panel 13.

The liquid crystal display panel 13 is a transmissive or semitransmissive type liquid crystal display panel. In this embodiment, the liquid crystal display panel 13 is of the semitransmissive type and has a panel body 25 having a liquid crystal material L sealed with a sealant 24 in a gap between an upper substrate 22 and a lower substrate 23. A semitransmitting-reflecting sheet 26 having both light-transmitting and -reflecting functions is provided underneath the panel body 25. As the liquid crystal material L, for example, TN liquid crystal or STN liquid crystal may be used. The upper substrate 22 comprises a transparent substrate 22a made of glass, for example. A transparent electrode 22b made of an ITO (Indium Tin Oxide) film is provided on a lower surface of the transparent substrate 22a. An alignment film 22c is provided on a lower surface of the transparent electrode 22b. The alignment film 22c is formed by applying an alignment treatment to a transparent polyimide resin film or the like. In addition, a polarizer 22d is provided on the upper surface of the transparent substrate 22a.

The lower substrate 23 comprises a transparent substrate 23a made of glass, for example. A transparent electrode 23b made of an ITO film is provided on the upper surface of the transparent substrate 23a. An alignment film 23c is provided on the upper surface of the transparent electrode 23b. The alignment film 23c is formed by applying an alignment treatment to a transparent polyimide resin film, for example. In addition, a polarizer 23d is provided on the lower surface of the transparent substrate 23a.

The semitransmitting-reflecting sheet 26 may be an aluminum-evaporated sheet formed so as to have light-transmitting properties, or a reflective polarizer, for example. It should be noted that a spacer (not shown) comprising silica balls or plastic balls, for example, is dispersedly provided in the gap between the upper and lower substrates 22 and 23, thereby ensuring a desired amount of gap.

In the backlight unit 7 of this embodiment, which comprises the optical member 1 and the backlight part 8, as shown in FIG. 4, illuminating light from the backlight part 8 passes through the optical windows 6 that function as pinholes and is collected by the convex lenses 2, thereby being formed into parallel rays and emitted toward the liquid crystal display panel 13 directly above the backlight unit 7.

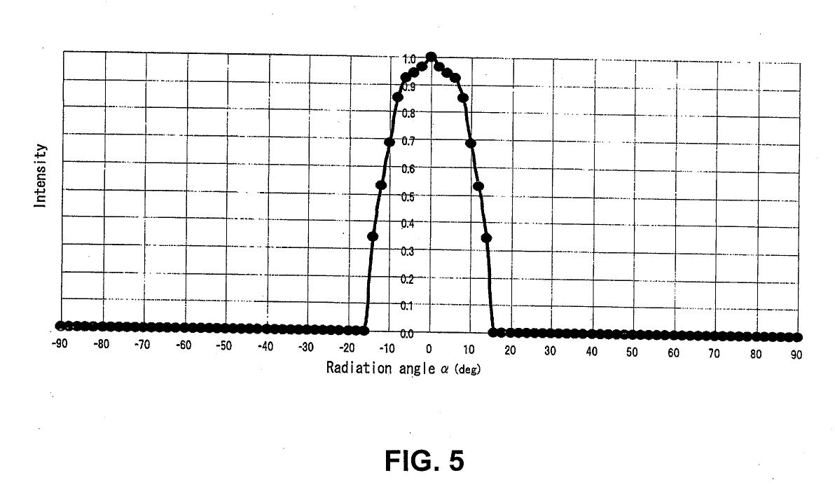

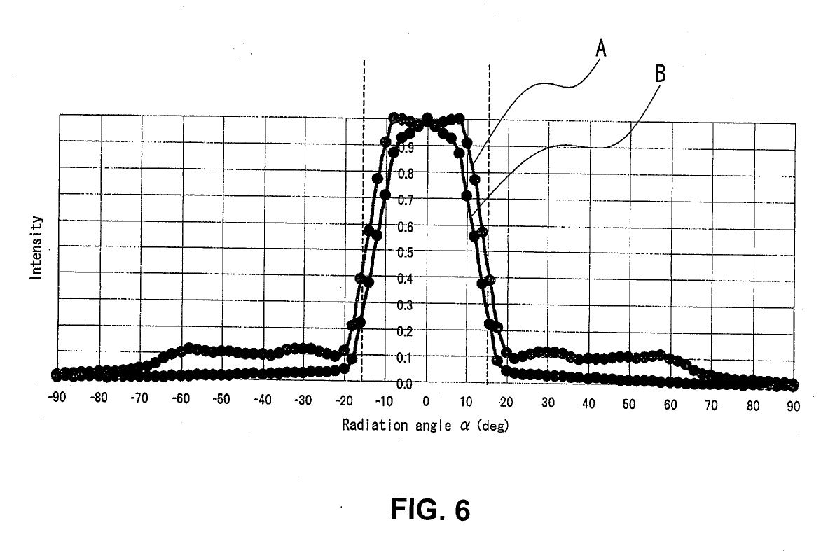

Next, the results of simulation concerning the light directivity characteristics of the optical member, backlight unit and display apparatus in this embodiment will be explained with reference to FIGS. 5 and 6.

FIG. 5 shows the results of simulation concerning the light directivity characteristics of the backlight unit 7 in this embodiment, which comprises the optical member 1 and the backlight part 8. It will be understood from FIG. 5 that the backlight unit 7 has very high directivity in the directly forward direction. As a comparative example, we performed simulation in the same way as the above for the technique disclosed in the aforementioned Japanese Patent Application Publication No. 2006-145653. The results of the simulation are shown in FIG. 6.

As will be understood from FIGS. 5 and 6, higher light directivity is obtained in this embodiment than in the comparative example. In FIG. 6, curve A represents the results of simulation in a case where the optical member sheet disclosed in the aforementioned Japanese Patent Application Publication No. 2006-145653 was placed only on a lightguide plate, and curve B represents the results of simulation in a case where the optical member sheet was placed on a backlight unit comprising a lightguide plate, a diffusing sheet, and two prism sheets (two prism sheets positioned so that the ridges of their prisms are perpendicular to each other in plan view).

It will be understood that in FIG. 6 light is emitted even in a range of from about 20° to about 80° in comparison to the simulation results in this embodiment shown in FIG. 5. In other words, the comparative example shown in FIG. 6 is inferior in the capability of blocking light traveling in oblique directions from the front surface of the optical member sheet, whereas the embodiment shown in FIG. 5 is superior in the capability of blocking light traveling in oblique directions from the front surface of the optical member.

Thus, in the optical member 1 of this embodiment, light that is to enter each convex lens 2 is narrowed down by the associated optical window 6, and light entering through the optical windows 6 is suppressed from scattering by the light-absorbing layer 4. Therefore, it is possible to prevent emission of light in oblique directions other than the directly forward direction. In the backlight unit 7 using the optical member 1, an image-forming optical system is formed so that illuminating light from the backlight part 8 is formed into parallel rays through the optical windows 6 and the convex lenses 2. Thus, exiting light having high directivity in the directly forward direction can be obtained. Accordingly, if the backlight unit 7 is used to illuminate a liquid crystal display panel of a liquid crystal display apparatus, the forward luminance of the liquid crystal display panel (i.e. the luminance of the liquid crystal display panel as viewed from directly in front of it) can be increased to a considerable extent. On the other hand, the luminance of the liquid crystal display panel as viewed from an oblique direction can be reduced considerably.

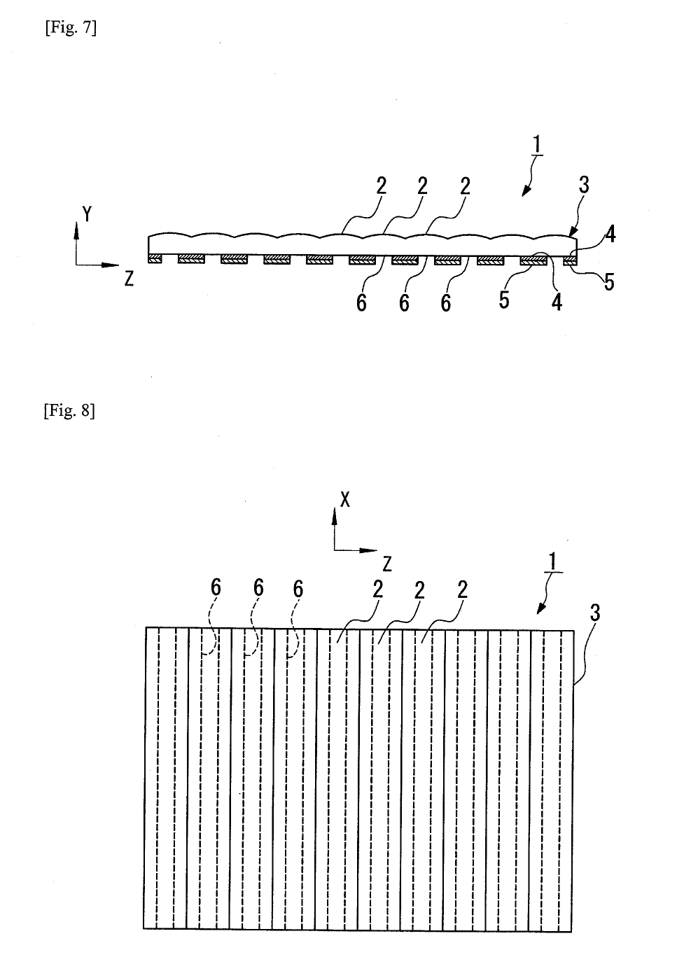

FIGS. 7 to 10 show another embodiment of the present invention. In the following description, elements that are substantially the same as those in the foregoing first embodiment are denoted by the same reference numerals as used in the first embodiment.

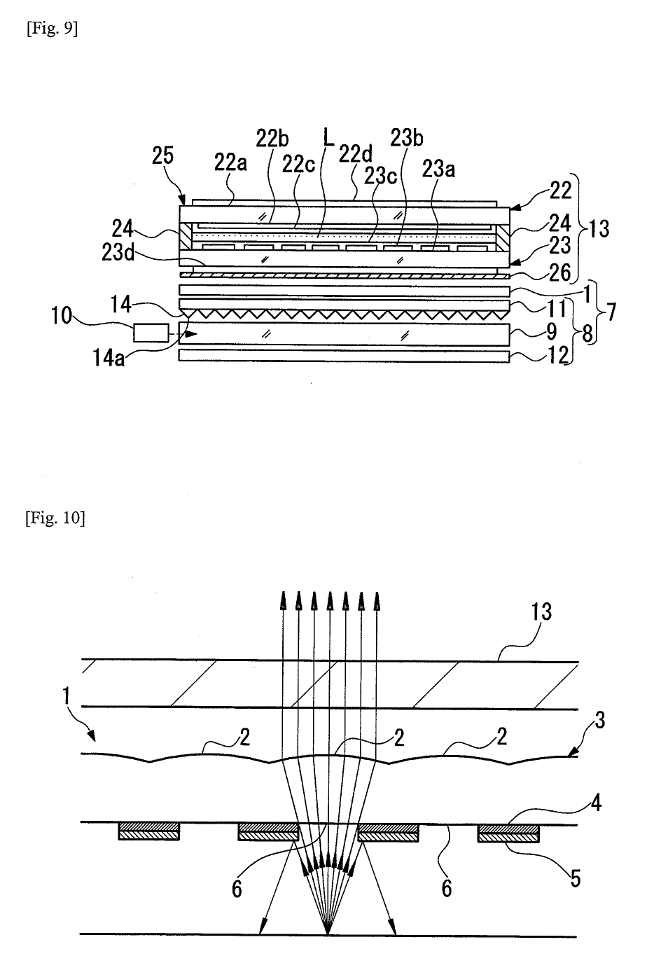

FIGS. 7 and 8 show an optical member 1 according to another embodiment of the present invention. The optical member 1 is basically the same as the optical member 1 in the above-described first embodiment. In this embodiment, however, the transparent lens layer 3 has on its front surface a plurality of elongated convex lenses (lenticular lenses) 2 of semicircular cross-section provided adjacent and parallel to each other. Optical windows 6 are formed at positions facing opposite the convex lenses 2, respectively, in the shape of slits with a predetermined width extending along the convex lenses 2. The center lines of the optical windows 6 are positioned directly under the ridges of the corresponding convex lenses 2. As shown in FIG. 9, the optical member 1 is disposed in a liquid crystal display apparatus in the same way as in the first embodiment and set so that light from a backlight part 8, which is a planar light source, is passed through the optical windows 6 and emitted from the convex lenses 2 as parallel rays of light. That is, the convex lenses 2 have one common focal plane that is substantially coincident with the exit surface of the backlight part 8.

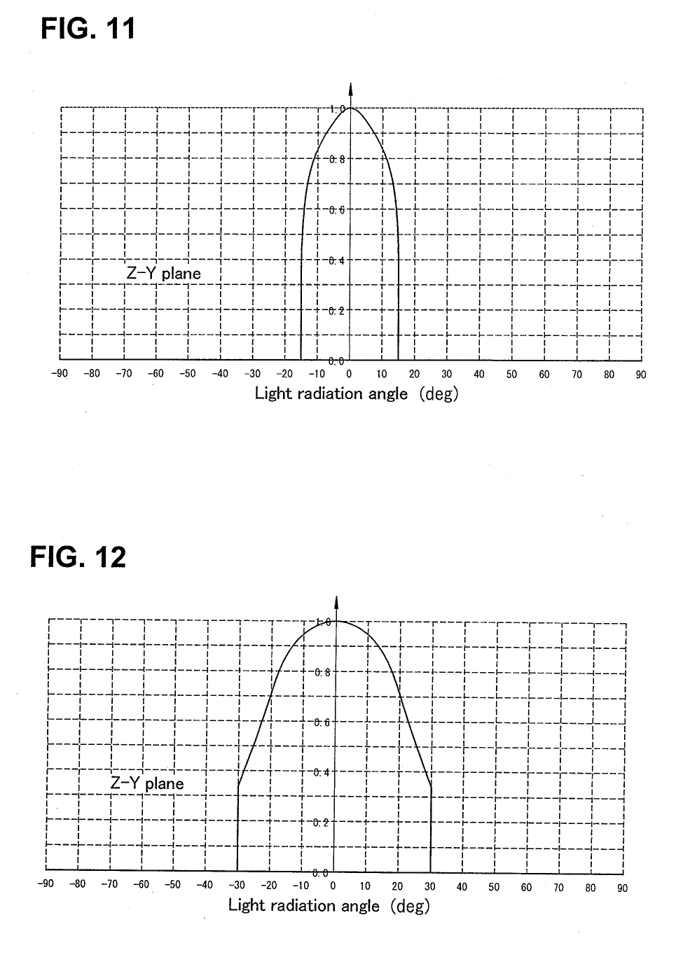

We simulated the light directivity characteristics of the backlight unit 7 according to the second embodiment, which comprises the optical member 1 and the backlight part 8. The results of the simulation reveal that as shown in FIG. 11 the backlight unit 7 has very high directivity in the directly forward direction in a plane perpendicular to the extension direction of the convex lenses 2 (i.e. Z-Y plane in the figure). Accordingly, emission of light in obliquely sideward directions is reduced in the Z-Y plane. As a comparative example, we performed simulation in the same way as the above for the technique disclosed in the aforementioned Japanese Patent Application Publication No. Hei 5-94731. The results of the simulation are shown in FIG. 12. It will be understood from comparison between FIGS. 11 and 12 that the optical member 1 according to the second embodiment provides higher directivity in the directly forward direction.

Accordingly, when the liquid crystal display panel 13 is placed upright, for example, and the optical member 1 is disposed parallel to the liquid crystal display panel 13 such that the convex lenses 2 extend in the vertical direction, it is possible to suppress light exiting rightward and leftward from the optical member 1. This makes it possible to increase the forward luminance on the surface of the liquid crystal display panel 13 and to prevent peeping sideways at the display surface.

The optical members according to the first and second embodiments dispense with the steps of stacking a multiplicity of layers and slicing the resulting stack, which have been required in the related conventional art. Therefore, these optical members can be produced at a reduced cost. The elongated convex lenses 2 in the second embodiment are arranged parallel to each other and can be produced at a lower cost than microscopic spherical convex lenses arranged in a matrix as in the first embodiment.

Although some embodiments of the present invention have been described above, the present invention is not necessarily limited to the foregoing embodiments but can be modified in a variety of ways without departing from the scope of the present invention.

Although in the first embodiment a plurality of convex lenses 2 are arranged in a matrix, the convex lenses 2 may be arranged in a zigzag or other pattern.

Although the first embodiment uses convex lenses 2 that are circular in plan view, it is also possible to use convex lenses that are quadrilateral in plan view like fly-eye lenses. Further, it is possible to use not only a spherical convex lens configuration as in the case of the convex lenses 2 but also other convex lens configurations, provided that the desired light-collecting effect can be obtained.

Although in the first and second embodiments the light-absorbing layer 4 and the light-reflecting layer 5 are laminated on the back side of the transparent lens layer 3, the light-absorbing layer 4 and the light-reflecting layer 5 may be formed as discrete sheet- or film-shaped members, for example, and provided on the back side of the transparent lens layer 3.

Although it is preferable to use white LEDs as the light source 10, as has been stated above, a linear fluorescent tube light source may also be used as the light source 10.

Although in the foregoing embodiments the liquid crystal display panel 13 is used as an image display panel, other types of image display panels may be used, for example, an electronic paper.

Further, the backlight unit may use various arrangements in addition to the above. For example, in the above-described embodiments, the backlight unit omits a diffusing sheet, which is a member for making light emitted from the lightguide plate even more uniform. However, such a diffusing sheet may be provided over the lightguide plate of the backlight unit. Although the above-described embodiments use a single prism sheet, two prism sheets may be used (i.e. two prism sheets arranged such that the ridges of their prisms are skew to each other).

What is claimed is:

1. An optical member comprising:
a transparent lens layer having a front surface and a back surface and having a plurality of convex lenses on the front surface;
a light-absorbing layer and a light-reflecting layer successively stacked on the back surface of said transparent lens layer; and
a plurality of optical windows extending through said light-absorbing layer and said light-reflecting layer in a direction in which said light-reflecting layer, said light-absorbing layer and said transparent lens layer are successively stacked, said optical windows being aligned with said convex lenses, respectively;
said convex lenses having one common focal plane that is located outside said optical member, said focal plane being adjacent and parallel to said light-reflecting layer.

2. The optical member of claim 1, wherein said convex lenses are arranged in a matrix on the front surface of said transparent lens layer, said convex lenses each having a spherical convex surface, and said optical windows are circular windows aligned with said convex lenses, respectively, in said direction of stacking.

3. The optical member of claim 1, wherein said convex lenses respectively have elongated convex surfaces of arcuate cross-section that extend parallel to each other on the front surface of said transparent lens layer, and said optical windows are elongated slits aligned with said elongated convex surfaces, respectively, in said direction of stacking.

4. A backlight unit comprising:
the optical member of claim 1; and
a backlight part serving as a planar light source that applies light to said optical member from a side thereof closer to said light-reflecting layer:
wherein said focal plane of said convex lenses of said optical member is substantially coincident with a light exit surface of said backlight part that faces said optical member.

5. The backlight unit of claim 4, wherein said backlight part comprises:
a lightguide plate disposed parallel to said optical member;
a light source disposed along a side edge surface of said lightguide plate to emit light into said lightguide plate; and
a prism sheet provided between said lightguide plate and said optical member to direct light from said lightguide plate to said optical member.

6. A display apparatus comprising:
a light-transmissive image display panel; and
the backlight unit of claim 5 that is disposed at a back side of said image display panel.

7. The display apparatus of claim 6, wherein said image display panel is a liquid crystal display panel.
